(19) United States
(12) Patent Application Publication
(10) Pub. No.: US 2005/0125980 A1
(43) Pub. Date: Jun. 16, 2005

(54) System and method of constructing wire wrap well screens

(76) Inventors: Donald E. Rakow JR., Rockwall, TX (US); Carl Ferguson, LaPorte, TX (US)

Correspondence Address: Joshua A. Griswold;Fish & Richardson, P.C., Suite 5000, 1717 Main Street, Dallas, TX, 75201, US

(21) Appl. No.: 10/733,614

(22) Filed: Dec. 11, 2003

(51) Int. Cl. B23Q 17/00; G01M 19/00

(52) U.S. Cl. 29/407.05; 29/456; 29/505; 29/715

(57) ABSTRACT

A device for constructing a wire wrapped screen winds a wrap wire substantially helically about a screen body by rotating the screen body about a screen body longitudinal axis while moving the screen body along the screen body longitudinal axis. The device includes a gauge measurement device adapted to measure a dimension between adjacent wraps of wrap wire on the screen body and a wrap wire measurement device adapted to measure a dimension of the wrap wire. A controller is coupled to the gauge measurement device and wrap wire measurement device, and is adapted to adjust the rate of movement of the screen body along the screen body longitudinal axis in relation to the dimension between adjacent wraps of wire on the screen body and/or the measured dimension of the wrap wire.

### TECHNICAL FIELD

This invention relates to wire wrapped screens, and more particularly to an improved system and method for constructing wire wrapped screens such as those used down hole in subterranean well applications.

### BACKGROUND

A wire wrapped screen is a tubular that incorporates a wire mesh adapted to filter particulate from passage between an exterior and an interior of the screen. One or more screens and other tubulars may be concentrically nested to form a well screen assembly. The well screen assembly is typically mounted in-line in a tubing string and run down hole in a subterranean well. Fluids are then produced from the formation or flowed into the well bore through the tubing string, and the well screen assembly operates to filter passage of particulate between the interior and the exterior of the tubing string.

The wire wrapped screen is constructed from a wrap wire that is helically wound around a body, for example, a plurality of elongate wires arranged to define a cylinder. The wire wrapped screen is generally fabricated by rotating the body about its central longitudinal axis, securing the wrap wire as the body rotates, and moving the body along its longitudinal axis relative to the incoming wrap wire, so that the wrap wire wraps in a helical fashion. Uniformity in the helical wraps is desired, because the distance between adjacent wrap wires, or screen gauge, is specified based on the size of particulate to be filtered. Variances in the wrap wire width affect the screen gauge. The rate at which the body is moved along its longitudinal axis also affects the screen gauge. If this rate is improperly set or varies, or the wrap wire width changes, the rate at which the body is moved along its longitudinal axis must be adjusted to obtain or maintain the desired screen gauge. Therefore, there is a need to produce a wire wrap screen having uniformity of screen gauge.

### SUMMARY

The present invention encompasses a system and method for producing a wire wrap screen that has improved uniformity of the screen gauge.

One illustrative embodiment includes a device for constructing a wire wrapped screen. The device has a screen body carrier adapted to carry an elongate screen body being rotated substantially about a screen body longitudinal axis. A wrap wire feed is provided and adapted to guide a wrap wire being wound about the screen body. The screen body carrier and wrap wire feed cooperate to move at least one of the screen body and wrap wire relative to the other and substantially parallel to the screen body longitudinal axis to wrap the wrap wire substantially helically about the screen body as the screen body rotates. A gauge measurement device is provided and adapted to measure a dimension between adjacent wraps of the wrap wire on the screen body. A controller is coupled to the gauge measurement device and adapted to adjust the wrapping of the wrap wire about the screen body to affect the dimension between adjacent wraps of wire on the screen body in relation to the measured dimension between adjacent wraps of the wrap wire on the screen body.

A wrap wire measurement device may be provided as an alternative to the gauge measurement device or in combination with the gauge measurement device. The wrap wire measurement device is adapted to measure a dimension of the wrap wire. If a wrap wire measurement device is provided, the controller may be coupled to the wrap wire measurement device and adapted to adjust the wrapping of the wrap wire about the screen body to affect the dimension between adjacent wraps of wire on the screen body in relation to the measured dimension of the wrap wire.

Another illustrative embodiment includes a method of constructing a screen. According to the method a wire is wrapped substantially helically about a screen body as the screen body rotates. At least one of the wire and screen body is translated substantially parallel to a screen body longitudinal axis. A dimension between adjacent wraps of the wire on the screen body is measured continuously during one or more intervals while wrapping the wire about the screen body. The wrapping of the wire about the screen body is adjusted to affect the dimension between adjacent wraps of wire on the screen body in relation to the measured dimension between adjacent wraps of the wire.

As an alternative to measuring a dimension between adjacent wraps of the wrap wire or in combination with the same, the method can include measuring a dimension of the wire continuously during an interval while wrapping the wire about the screen body. If a dimension of the wire is measured, then the method may include adjusting the wrapping of the wire about the screen body to affect the dimension between adjacent wraps of wire on the screen body in relation to the measured dimension of the wire.

Another illustrative embodiment includes a device for constructing a wire wrapped screen. The device has a screen body carrier adapted to carry an elongate screen body. A wrap wire feed is provided and adapted to guide a wrap wire being wound substantially helically about the screen body. A measurement device is provided for measuring at least one of a dimension between adjacent wraps of wire about the screen body and a dimension of the wrap wire. A marking device is provided and actuable to mark the wire wrapped screen. A controller is coupled to the measurement device and the marking device. The controller is adapted to actuate the marking device in relation to a measured dimension from the measurement device.

Another illustrative embodiment includes a method of constructing a screen. According to the method wrapping a wire substantially helically about a screen body. At least one of a dimension between adjacent wraps of wire about the screen body and a dimension of the wrap wire is measured. The screen is marked while wrapping the wire about the screen body in relation to the measured dimension.

Another illustrative embodiment includes a device for constructing a wire wrapped screen. The device has a screen body carrier adapted to carry an elongate screen body and a wrap wire feed adapted to guide a wrap wire being wound substantially helically about the screen body. At least one measurement device is provided and adapted to measure at least one of a dimension between adjacent wraps of wire about the screen body and a dimension of the wrap wire while the wrap wire is being wrapped about the screen body.

Another illustrative embodiment includes a method of constructing a screen. According to the method a wire is wrapped substantially helically about a screen body. At least one of a dimension between adjacent wraps of wire about the screen body and a dimension of the wrap wire is measured while the wire is being wrapped substantially helically about the screen body.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of an illustrative wire wrapping system constructed in accordance with the invention;

FIG. 2 is a perspective detail view of the head, wrap wire feed assembly, and welding arm of the wire wrapping system of FIG. 1;

FIG. 3 is a schematic of a control module for use in a wire wrapping system constructed in accordance with the invention;

FIG. 4A is a cut-away perspective view of a wire wrapped screen having a tubular screen body and without axial body wires;

FIG. 4B is a cut-away perspective view of a wire wrapped screen having a tubular screen body with axial body wires; and

FIG. 5 is a cut-away perspective view of a wire wrapped screen having a screen body including another wire wrapped screen with external axial body wires.

Like reference symbols in the various drawings indicate like elements.

### DETAILED DESCRIPTION

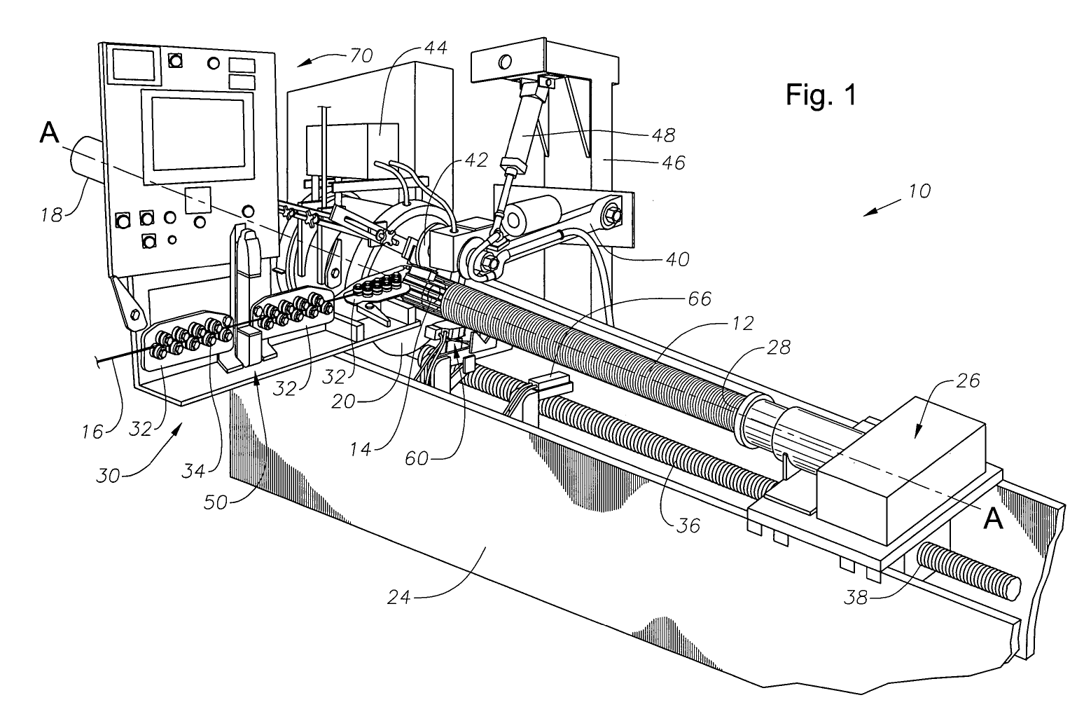

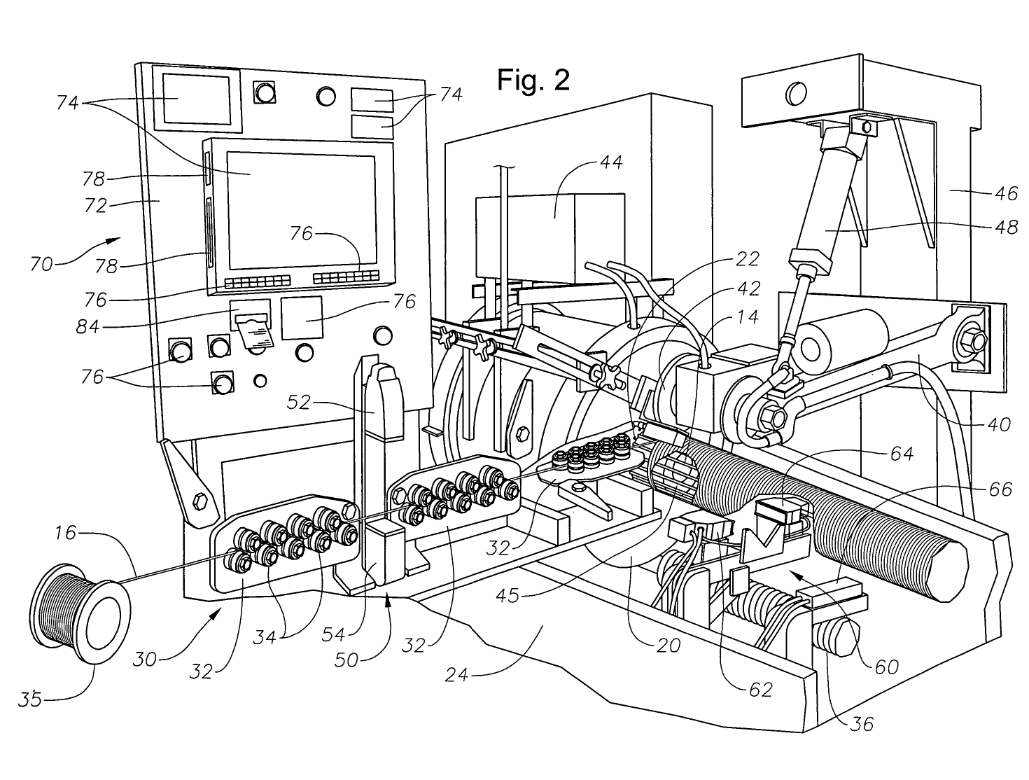

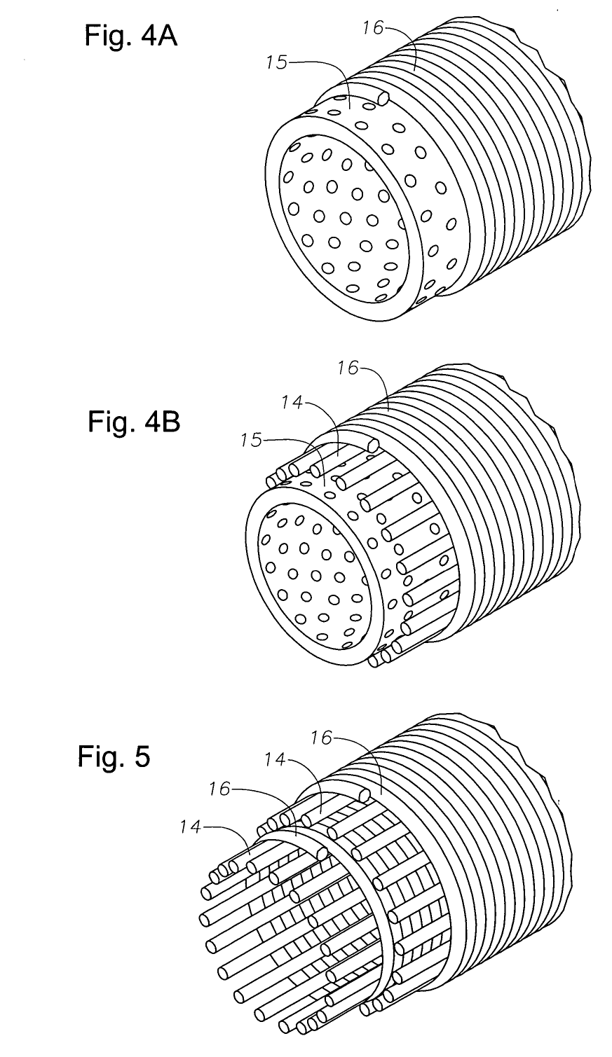

Referring to FIGS. 1 and 2, an illustrative wire wrapping system 10 constructed in accordance with the invention is depicted fabricating an elongate wire wrapped screen 12 suitable for incorporation into a well screen assembly (not specifically shown). The wire wrapped screen 12 is constructed from a plurality of axial body wires 14 and a wrap wire 16. The axial body wires 14 extend along a length of the wire wrapped screen 12 and are arranged to define a cylinder and spaced from one another to define longitudinal gaps. The wrap wire 16 is substantially helically wrapped about and joined to the axial body wires 14. Although described herein with reference to a wire wrapped screen 12 having a wrap wire 16 helically wrapped about axial body wires 14, the concepts described herein are equally applicable to a wire wrapped screen having a wrap wire 16 helically wrapped around an apertured body 15 with or without axial body wires 14 (see FIG. 4), such as a slotted or apertured tubular or an expanded screen, or having multiple layers of axial body wires 14 and wrap wire 16 (see FIG. 5).

In the illustrative wire wrapping system 10, the wrap wire 16 is joined to the axial body wires 14 by welding, but it is within the scope of the invention that the wrap wire 16 and axial body wires 14 be joined by other methods, including brazing, adhesive, wire tie, or otherwise. For convenience of reference, an axial centerline of the wire wrapped screen 12, to which axial body wires 14 are substantially parallel and substantially equally radially offset from, is referred to herein as axis A-A.

The illustrative wire wrapping system 10 includes a head 20 driven to rotate about axis A-A. In the illustrative wire wrapping system 10, the axial body wires 14 pass through a plurality of apertures 22 in the head 20 to rotate about axis A-A as the head 20 rotates. The apertures 22 are arranged in a circle, and thereby hold the axial body wires 14 in spaced relation defining a cylinder. The head 20 resides about one end of an elongate bed 24 that extends substantially parallel to, but offset from, axis A-A. Opposite the elongate bed 24 and extending outward from the head 20 is a tubular wire support body 18 in which the axial body wires 14 rest.

The elongate bed 24 carries a tail support 26 having a tail chuck 28 adapted to receive and grasp ends of the axial body wires 14. The tail chuck 28 cooperates with the head 20 to support the axial body wires 14 substantially parallel to axis A-A. The tail chuck 28 is also driven to rotate about axis A-A at the same rate as the head 20 The tail support 26 may be adapted to move at an adjustable rate along the length of the elongate bed 24, substantially parallel to axis A-A. Moving the tail support 26 away from the head 20 along the elongate bed 24 draws the axial body wires 14 from the tubular wire support body 18, through the head 20, and along axis A-A.

In the illustrative wire wrapping system 10, the tail support 26 is moved using a helical drive screw 36. The tail support 26 receives the helical drive screw 36 with a female profile 38 configured such that rotation of the drive screw 36 in one direction screws the tail support 26 away from the head 20 and rotation of the drive screw 36 in an opposite direction screws the tail support 26 toward the head 20. The rate at which the tail support 26 moves along the elongate bed 24 is proportional to the rotational speed of the helical drive screw 36. The helical drive screw 36 is thus driven to move the tail support 26 along the elongate bed 24. Although discussed with respect to a helical drive screw 36 and female profile 38, it is within the scope of the invention that other drive arrangements be utilized. For example, the tail support 26 may be moved along the elongate bed 24 using a linear actuator, gear train, or other system.

As best seen in FIG. 2, a wrap wire feed assembly 30 extends laterally outward from the elongate bed 24 and substantially perpendicular to the axis A-A. The wrap wire feed assembly 30 defines a wire track 32 that receives wrap wire 16 from a source reel 35 and guides the wrap wire 16 to the axial body wires 14 in a controlled manner. A height of the wire track 32 is adjustable relative to the axis A-A, so that the wrap wire 16 can be guided to tangent the outward surface of the cylinder defined by the axial body wires 14.

In the illustrative wire wrapping system 10, the wire track 32 includes a plurality of circumferentially grooved, cylindrical rollers 34, oriented to rotate in substantially perpendicular planes and aligned along a common axis. The rollers 34 receive the wrap wire 16 in their respective groove and cooperate to guide the wrap wire 16 substantially perpendicular to, but offset from, axis A-A to tangent the axial body wires 14. Although described herein with respect to a plurality of cylindrical rollers, it is within the scope of the invention to utilize other configurations of wire track 32. For example, the wire track 32 can be a simple grooved pathway or otherwise.

In an instance where the tail support 26 is adapted to be selectively affixed to the elongate bed 24 at differing distances from the head 20, the wrap wire feed assembly 30 or a portion thereof, is carried to move along the elongate bed 24 substantially parallel to axis A-A. As above, the wrap wire feed assembly 30 can be moved using a helical drive screw, linear actuator, gear train or other system.

A welding arm 40 is movably positioned over the elongate bed 24 opposite the wrap wire feed assembly 30. The welding arm 40 includes a compression wheel 42 rotatable in a plane that is substantially perpendicular to axis A-A and substantially aligned with the incoming wrap wire 16. Aback-up mandrel 45 extends outward from the head 20 centered on axis A-A and encircled by the axial body wires 14. The back-up mandrel 45 is sized so that its outer circumference substantially abuts the inward facing surfaces of the axial body wires 14 and is axially positioned along axis A-A to substantially coincide with the incoming wrap wire 16. The compression wheel 42 is movable into and out of a position by which its outer circumference bears against the wrap wire 16, pressing the wrap wire 16 into contact with the axial body wires 14 and against the back-up mandrel 45. The amount of force exerted by the compression wheel 42 on the wrap wire 16 and axial body wires 14 is adjustable by adjusting the position of the pressing wheel 42. A power source 44 is coupled to the head 20 and to the compression wheel 42 to apply a current across the head 20 and pressing wheel 42 through the axial body wires 14 and wrap wire 16 to compression weld the axial body wires 14 and wrap wire 16 at the point of compression by the compression wheel 42.

In the illustrative wire wrapping system 10, the welding arm 40 is mounted at one end to a fixed body 46 and rotatable about an axis parallel, but offset from, axis A-A. A linear actuator 48, such as a hydraulic or pneumatic piston or an electro-mechanical device, links the welding arm 40 and fixed body 46. Extending the linear actuator 48 rotates the welding arm 40 towards the wire wrap screen 12 being constructed, and once the compression wheel 42 is pressing the wrap wire 16 and axial body wires 14 against the back-up mandrel 45, further extending the linear actuator increases the force exerted on the wrap wire 16 and axial body wires 14. Retracting the linear actuator 48 decreases the force exerted on the wrap wire 16 and axial body wires 14 and retracts the welding arm 40 away from the wire wrap screen 12 being constructed.

A wrap wire dimensional analyzer system 50 is positioned to measure one or more dimensions of the wrap wire 16 received from the source reel 35. The dimensional analyzer system 50 may be positioned in the wrap wire feed assembly 30 with portions of the wrap wire feed assembly 30 on either side of the dimensional analyzer system 50 configured to stabilize the passage of the wrap wire 16 through the dimensional analyzer system 50. In the illustrative wire wrapping system 10, the dimensional analyzer system 50 includes a light projector unit 52 opposed to and projecting light across the incoming wrap wire 16 into a light receiver unit 54. The light receiver unit 54 then determines at least one dimension of the wrap wire 16, for example, by measuring the width of light projected onto the receiver unit 54 as compared to the width of the light emitted by the light projector unit 52. In the illustrative wire wrapping system 10, the light projector unit 52 is positioned to project light down on the incoming wrap wire 16 into the light receiver unit 54 substantially perpendicular to, but offset from, the axis A-A to determine a width of the wrap wire 16; however, it is within the scope of the invention that the light projector unit 52 and light receiver unit 54 or multiple light projector units 52 and receiver units 54 be positioned to determine additional or alternate dimensions of the incoming wrap wire 16. The dimensional analyzer system 50 of the illustrative wire wrapping system 10 also optionally includes a video imager, in this instance incorporated into the light projector unit 52, directed at the wrap wire 16 to capture one or more video images of the wrap wire 16 fed through the wrap wire feed assembly 30. It is within the scope of the invention to use alternate or additional devices to the light projector unit 52 and light receiver unit 54 to measure the wrap wire 16, including, for example, mechanical measurement devices, acoustic measurement devices, other optical or light-based measurement devices (ex. a video imager device that digitally images the wrap wire and determines one or more dimensions from the image), or otherwise. The wrap wire dimensional analyzer system 50 can be operated to measure the wrap wire 16 periodically or continuously in real-time.

A screen gauge analyzer system 60 is positioned to measure the gauge, or distance between adjacent wraps of wrap wire 16, on the screen 12. The screen gauge analyzer system 60 may be positioned above the elongate bed 24 and below the wire wrapped screen 12 being fabricated to measure the gauge at a tangent of the wire wrapped screen 12. In the illustrative wire wrapping system 10, the screen gauge analyzer system 60 includes a light projector unit 62 opposed to and projecting light across the incoming wrap wire 16 into a light receiver unit 64. The light receiver unit 64 then determines a screen gauge of the wire wrap screen 12 by measuring the width of light projected onto the receiver unit 64 as compared to the width of the light emitted by the light projector unit 62. In the illustrative wire wrapping system 10, the light projector unit 62 is positioned to project light across an edge of the wire wrapped screen 12 into the light receiver unit 64 substantially perpendicular to, but offset from, the axis A-A to determine a gauge of the wire wrapped screen 12; however, it is within the scope of the invention that the light projector unit 62 and light receiver unit 64 or multiple light projector units 62 and receiver units 64 be positioned to determine the screen gauge at additional or alternate positions. The screen gauge analyzer system 60 of the illustrative wire wrapping system 10 also optionally includes a video imager, in this instance incorporated into the light projector 62, directed at the wire wrapped screen 12 to capture one or more video images of the wire wrapped screen 12. It is within the scope of the invention to use alternate or additional devices to the light projector unit 62 and light receiver unit 64 to measure the screen gauge, including, for example, mechanical measurement devices, acoustic measurement devices, other optical or light-based measurement devices (ex. a video imager device that digitally images the wrap wire and determines one or more dimensions from the image), or otherwise. The screen gauge analyzer system 60 can be operated to measure the gauge periodically or continuously in real-time.

The wire wrapping system 10 includes a control module 70. The control module 70 includes a user interface panel 72 having one or more displays 74, one or more user input devices 76 (ex. keyboard, touchscreen, voice recognition system), and one or more removable media drives 78 for reading and or writing computer readable media. The control module 70 may also include a printer 84 or other data output device.

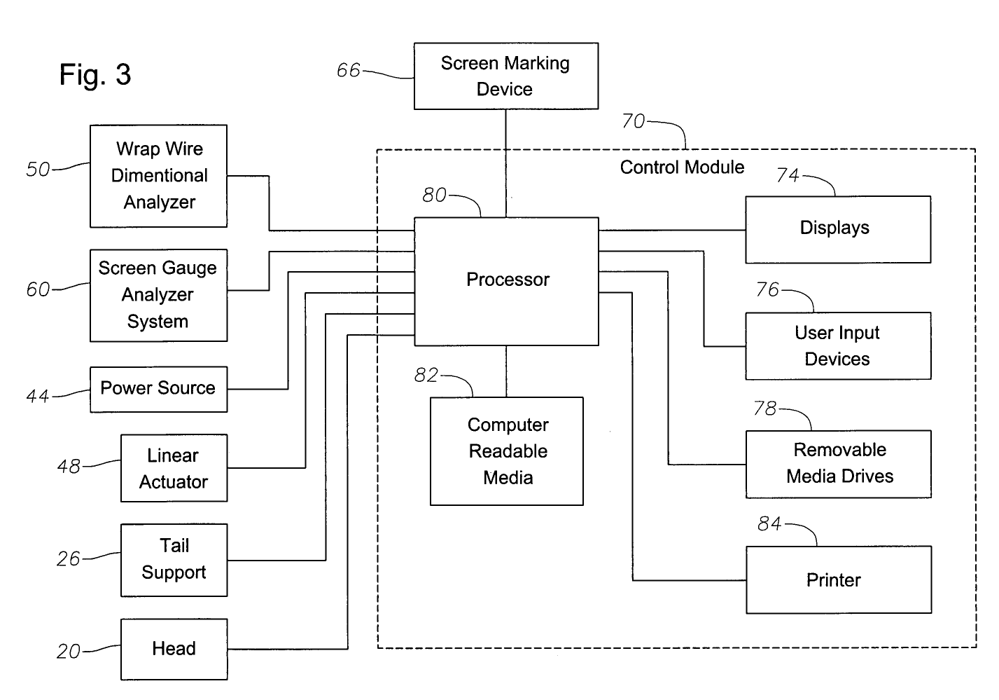

Referring to FIG. 3, the control module 70 includes a processor 80 and a computer readable media 82, for example a memory or hard drive. The computer readable media 82 includes operating instructions for the processor 80 for operation of the control module 70 described herein. The computer readable media 82 can be a removable media inserted through the drive 78, a media installed in the control module 70, or a combination of both. The control module 70 is coupled to the wire wrap dimensional analyzer system 50 to receive data about the incoming wrap wire 16. The control module 70 is also coupled to the screen gauge analyzer system 60 to receive data about the screen 12 being produced. The control module 70 is adapted to control the speed at which the head 20 rotates and the rate at which the tail support 26 moves along the elongate bed 24. In the illustrative wire wrapping system 10 described herein, the control module 70 controls the rate at which the tail support 26 moves along the elongate bed 24 by controlling the rotational speed of the helical drive screw 36. Also, the control module 70 can take the length of the wire wrap screen 12 being constructed as an input, and can stop the screen construction process when the specified length is reached.

In constructing a wire wrapped screen 12, the control module 70 operates to produce a desired screen gauge. From operator input including the desired screen gauge, the control module 70 measures the screen gauge as the wire wrapped screen 12 is being produced, compares the measured screen gauge to the desired screen gauge, and adjusts the rate at which the tail support 26 moves away from the head 20 to maintain the desired gauge. Measurements of screen gauge are obtained from the screen gauge analyzer system 60. Operator input may further include a desired tolerance for the screen gauge. If the screen gauge exceeds the tolerance, then the control module 70 adjusts the tail support 26 transit rate and/or the head 20 rotational rate to compensate. However, if the tolerance is not exceeded, then the control module 70 does not make an adjustment. The tolerance can include an acceptable screen gauge high and low tolerance. Using measurements obtained from the screen gauge analyzer system 60, the control module 70 can be configured not only to display the currently measured screen gauge, but to log the screen gauge over an interval during the wrapping of the screen 12 or over the entire construction process. Knowing the tail support 26 transit rate, the control module 70 is able to log screen gauge against a longitudinal dimension of the wire wrapped screen 12. In an instance where the screen gauge analyzer system 60 includes a video imager, the images captured from the video imager can be logged also, and can be logged against the longitudinal dimension of the wire wrapped screen 12. Thereafter, the logged data can be output, for example, to the printer 84, saved to a removable media by the media drive 78, or accessed remotely on a network, if the control module 70 is coupled to a network.

The control module 70 may further measure a width dimension of the wrap wire 16 with the wrap wire dimensional analyzer system 50, anticipate the effect of wrap wire 16 width variations on the screen gauge and thereafter correct for the wrap wire 16 width variations. For example, if the width of the wrap wire 16 increases and the tail support 26 transit rate is constant, the screen gauge decreases. If the width of the wrap wire 16 decreases, for a given tail support 26 transit rate, the screen gauge increases. Therefore, upon determining that the wrap wire 16 width has increased, the control module 70 can increase the tail support 26 transit rate, with a constant tail support 26 transit rate, decrease the head 20 rotational rate, or adjust both the tail support 26 transit rate and head 20 rotational rate to increase the screen gauge. Likewise, if the width of the wrap wire 16 decreases, the control module 70 can decrease the tail support 26 transit rate, with a constant tail support 26 transit rate, increase the head 20 rotational rate, or adjust both the tail support 26 transit rate and head 20 rotational rate to decrease the screen gauge. The distance from the point at which the wrap wire 16 width is measured to the point at which the wrap wire 16 is contacted to an axial body wire 14 can be input into the control module 70 together with the outer diameter of the cylinder defined by the axial body wires 14. From this information, and knowing the rate at which the head 20 is turning, the control module 70 can make adjustments at substantially the same time that the change in wrap wire 16 width contacts the axial body wires 14 and begins to affect the screen gauge. Using measurements obtained from the wrap wire dimensional analyzer system 50, the control module 70 can be configured not only to display the currently measured wrap wire dimension, but to log the wrap wire dimension over an interval during the wrapping of the screen 12 or over the entire construction process. Knowing the tail support 26 transit rate, the control module 70 is able to log wrap wire dimension against a longitudinal dimension of the wire wrapped screen 12. In an instance where the wrap wire dimensional analyzer system 50 includes a video imager, the images captured from the video imager can be logged also, and can be logged against the longitudinal dimension of the wire wrapped screen 12. Thereafter, the logged data can be output, for example, to the printer 84, saved to a removable media by the media drive 78, or accessed remotely on a network, if the control module 70 is coupled to a network.

The operator may manually control the amperage of the current supplied across the head 20 and compression wheel 42 to weld the wrap wire 16 and axial body wires 14. Alternately or in combination with manual control, the control module 70 may be configured to control the power source 44. In an instance where there is complete or partial manual control of the power source 44, the control module 70 may output the desired amperage on the display 74 and the operator can make the appropriate adjustment to the power source 44. In an instance where there is complete control of the power source 44 by the control module 70, the control module 70 may output the desired amperage on the display 74. The desired amperage can be determined by the control module 70 using parameters such as the rotational speed of the head 20, the dimension of the wrap wire 16, and inputs from the operator such as wrap wire 16 and axial body wire 14 materials and screen outer diameter input through the user input devices 76. The amperage can be calculated from the screen parameters or values representative of the amperage may be retrieved from values stored and correlated to the screen parameters on a look-up table on the computer readable media 78.

Optionally, the control module 70 may be adapted to control the amount of force applied by the compression wheel 42, for example by controlling the extension or retraction of the linear actuator 48. In an instance where the linear actuator 48 is a hydraulic or pneumatic cylinder, the control module 70 may be adapted to control the hydraulic or pneumatic pressure supplied to the cylinder. In an instance where the control module 70 is not configured to control the amount of force applied by the compression wheel 42, the control module 70 may determine the appropriate force or force related parameter (ex. air pressure for a pneumatic linear actuator) and indicate the force or force related parameter to an operator via the display 74. Exemplary loadings by the compression wheel 42 for various screen construction scenarios can be calculated from the screen parameters or values representative of the loadings can be retrieved from values stored and correlated to the screen parameters on a look-up table on the computer readable media 82.

A screen marking device 66 can be provided adjacent to the wire wrapped screen 12 for placing markings on the wire wrapped screen 12 during the construction process. The control module 70 is coupled to the screen marking device 66 to actuate the screen marking device 66. In the illustrative wire wrapping system 10, the screen marking device 66 is an ink or paint jet operable to spray one or more colors of ink or paint on the exterior of the wire wrapped screen 12 in one or more patterns. The pattern may as simple as a dot or a undefined mark, or the screen marking device 66 may be operable to apply more complex patterns such as a symbols or text. It is within the scope of the invention that the screen marking device 66 be other than an ink or paint sprayer, for example, but in no means by limitation, a device that applies a physical tag, by adhesive or other form of attachment, to the wire wrapped screen 12 or a device that affects the finish of the wire wrapped screen 12 by chemical or mechanical etching or mechanical means.

The control module 70 can be adapted to mark the wire wrapped screen 12 according to data received from one or more of the wrap wire dimensional analyzer system 50, the screen gauge analyzer system 60, or the other systems coupled to the control module 70. For example, the control module can actuate the marking device 66 in relation to variances in screen gauge and/or wrap wire dimension. If a variance in the measured screen gauge exceeds a specified high or low gauge marking tolerance (which may be different than the high and low screen gauge tolerance discussed above), the control module 70 actuates the marking system 66 to mark the wire wrapped screen 12. The distance from where the screen gauge analyzer system 60 measures screen gauge to the point of marking by the marking system 66 can be input into the control module 70. Using this distance together with the tail support 28 transit rate, screen outer diameter, and screen rotational rate, the control module 70 can actuate the marking system 66 to deposit a mark on the screen 12 that substantially coincides with the position of the measured variation on the wire wrapped screen 12 and indicating to the operator the location of the variation. If a variance in the measured wrap wire 16 dimension (ex. width) exceeds a specified high or low wrap wire marking tolerance, the control module 70 can actuate the marking device 66, as above, and the mark can substantially coincide with the position of the measured variation on the wire wrapped screen 12.

The color, symbol, size, and text of the marking can be used to communicate information about why the marking was placed on the wire wrapped screen 12. For example, in an instance where the screen marking device 66 is operable to mark in two or more colors, one color can be used to indicate variances of screen gauge and another color used to indicate variances of wrap wire dimension. In another example, different colors can be used to indicate the magnitude and/or direction (over or under) of a variance. In an instance where the screen marking device 66 is operable to mark with different symbols, different symbols can be used to indicate variances of wrap wire dimension and screen gauge. Together with symbols, another indicator such as size of the marking, color of the marking, or text can used to indicate the magnitude and/or direction (over or under) of the variance. Parameters of the screen (for example, screen gauge, gauge tolerance, screen diameter or length, and screen material) as well as magnitude and/or direction of measured variances can be marked on the wrapped wire screen 12 in text. It is within the scope of the invention to use any combination of color, symbol, marking size, and text to denote the parameters of the wire wrapped screen 12 and/or the measured variances in screen gauge and wrap wire dimension.

The control module 70 and screen marking device 66 have applicability on a wire wrapping system without the ability to adjust for variances in screen gauge or wrap wire 16 dimension or with the ability to adjust for variances in screen gauge and/or wrap wire 16 dimension disabled. Thus, for example, in such a system, when a variance of screen gauge or wrap wire 16 dimension exceeds its respective high or low tolerance, the control module 70 operates to mark the wire wrapped screen 12 as discussed above. Thereafter, the operator can view the marking and, if necessary, attempt to repair the variance.

In each instance above, measurements and adjustments may occur periodically during the construction of the wire wrapped screen 12, continuously during intervals (time or distance) in the screen construction, or continuously throughout the screen construction. Also, the control module 70 can be configured to display, as well as, log (to the computer readable media 82) the measurements obtained from the screen gauge analyzer system 60 and/or the wrap wire dimensional analyzer 50 and information about the screen construction process. The information about the screen construction process may include, for example, screen rotational speed, tail support 26 transit rate, linear actuator 48 position, and power source 44 amperage. The measurements and information can be logged during one or more intervals of the construction of the screen 12 or over the entire construction process. The measurements and information can be logged against a longitudinal dimension of the wire wrapped screen 12. The logged data can be output, for example, to the printer 84, saved to a removable media by the media drive 78, or accessed remotely on a network, if the control module 70 is coupled to a network.

In operation, a plurality of axial body wires 14 are received in the head 20 with a short length of the axial body wires 14 extending outward from the head 20 over the elongate bed 24. A remainder of the length of the axial body wires 14 rests in the tubular wire support body 18 opposite the elongate bed 24. With the tail support 26 positioned near the head 20, the end of each axial body wire 14 is secured in the tail chuck 28. A length of the axial body wires 14 is chosen to be at least slightly longer than the specified length of the wire wrapped screen 12 being constructed. A wrap wire 16 is received in the wrap wire feed assembly 30 with its end proximal to the axial body wires 14. The control module 70 prompts the user for inputs. The inputs depend on the configuration of the control module 70 as discussed above, but can include, among others, screen length, the outer diameter of the cylinder formed by the axial body wires, head rotational speed, desired screen gauge, screen gauge tolerance, wrap wire width, marking tolerances, power supply amperage, and compression wheel force.

The compression wheel 42 is lowered to compress the wrap wire 16 and the axial wires 14 against the back-up mandrel 45. The amount of force exerted by the compression wheel 42 is adjusted by the operator or by the control module 70 as discussed above. Upon application of the compression wheel 42 against the wrap wire 16 and axial body wires 14, the control module 70 can begin rotating the head 20 and tail chuck 28 while applying amperage across the interface of the wrap wire 16 and axial body wires 14 to weld the wrap wire 16 to the axial body wires 14. Simultaneously, the control module 70 operates to control the transit rate of the tail support 26 to obtain the desired screen gauge.

Utilizing inputs from the screen gauge analyzer system 60, the control module 70 increases, decreases, or maintains the transit rate of the tail support 26 and/or the rotational rate of the head 20 (and thus axial body wires 14) to maintain the desired screen gauge. If the screen gauge increases from the desired screen gauge, the control module 70 decreases the transit rate of the tail support 26 and/or increases the rotational rate of the axial body wires 14. If the screen gauge decreases from the desired screen gauge, the control module 70 increases the transit rate of the tail support 26 and/or decreases the rotational rate of the axial body wires 14. When the desired screen gauge is reached or if the measured screen gauge does not substantially depart from the desired screen gauge, the control module 70 maintains the transit rate of the tail support 26 and the rotational rate of the axial body wires 14. In an instance where a high and low tolerance is an input to the control module 70, the control module adjusts the transit rate of the tail support 26 and/or rotational rate of the axial body wires 14 to maintain the screen gauge within the specified tolerance. If a variance in the screen gauge exceeds a specified high tolerance, the control module 70 operates to decrease the transit rate of the tail support 26 and/or increase the rotational rate of the axial body wires 14. If the variance in the screen gauge exceeds a specified low tolerance, the control module 70 operates to increase the transit rate of the tail support 26 and/or decrease the rotational rate of the axial body wires 14. When the variance in the screen gauge comes within the specified tolerance or is within the specified tolerance, the control module operates to maintain the transit rate of the tail support 26 and/or rotational rate of the axial body wires 14. The adjustments in transit rate and rotational rate can occur without stopping the rotation of the axial body wires 14 during the wrapping of the wrap wire 16 about the axial body wires 14.

Utilizing inputs from the wrap wire dimensional analyzer 50, the control module 70 increases, decreases, or maintains the transit rate of the tail support 26 and/or rotational rate of the axial body wires 14 to compensate for variances in wrap wire 16 width to maintain the desired screen gauge. If the measured wrap wire 16 width increases over the initial or specified wrap wire 16 width, the control module 70 operates to increase the transit rate of the tail support 26 and/or decrease the rotational rate of the axial body wires 14. If the measured wrap wire 16 width decreases, the control module 70 operates to decrease the transit rate of the tail support 26 and/or increase the rotational rate of the axial body wires 14. If the measured wrap wire 16 width does not depart from the initial or specified wrap wire 16 width, the control module 70 maintains the transit rate of the tail support 26 and the rotational rate of the axial body wires 14. In an instance where a high and low wrap wire tolerance is an input to the control module 70, the control module adjusts the transit rate of the tail support 26 to maintain the screen gauge within the specified tolerance. If a variance in the wrap wire 16 width exceeds a specified high tolerance, the control module 70 operates to decrease the transit rate of the tail support 26 and/or increase the rotational rate of the axial body wires 14. If the variance in the wrap wire 16 width exceeds a specified low tolerance, the control module 70 operates to increase the transit rate of the tail support 26 and/or decrease the rotational rate of the axial body wires 14. When the variance in the wrap wire 16 width comes within the specified tolerance or is within the specified tolerance, the control module operates to maintain the transit rate of the tail support 26 and rotational rate of the axial body wires 14. The adjustments in transit rate and rotational rate can occur without stopping the rotation of the axial body wires 14 during the wrapping of the wrap wire 16 about the axial body wires 14.

Using inputs from the wrap wire dimensional analyzer 50 and screen gauge analyzer 60, the control module 70 operates the marking system 66 to mark the wire wrapped screen 12 as it is being constructed. The control module 70 marks the wire wrapped screen 12 when a measured variance exceeds a high or low marking tolerance. For example, if the screen gauge exceeds a high or low screen gauge marking tolerance, the control module operates the marking system 66 to mark the wire wrapped screen 12 substantially coinciding with the position of the measured variance on the constructed portion of the screen 12. The wire wrapped screen 12 is marked during the wrapping of the wrap wire 16 about the axial body wires 14, and the rotation of the axial body wires need not be stopped.

Data from the wrap wire dimensional analyzer system 50 and screen gauge analyzer system 60 is accessible to an operator through the displays 74. The data can also be logged to a computer readable media 82, and if desired, can be logged against a length of the wire wrapped screen 12 so that the position of variations in the measured dimensions can be easily correlated to the constructed wire wrapped screen 12. On completion of the wrap wire screen 12 or at some time prior to completion, the logged data can be output to the printer 84, saved to a removable media by the media drive 78, or accessed remotely on a network, if the control module 70 coupled to a network.

If screen length is input to the control module 70, the control module operates to cease production of the wire wrap screen 12 by stopping the power source 44, the rotation of head 20 and tail chuck 28, and movement of the tail support 26. Thereafter, the wire wrapped screen 12 is removed from the wire wrapping system 10 and excess length of the axial body wires 14 removed.

The invention has many significant advantages. For example, by compensating for wrap wire width during construction of a wire wrapped screen, the screen gauge is more uniform and the tolerance of the gauge, tighter. Likewise, by monitoring the gauge during the construction of the wire wrapped screen, variances in screen gauge due to other influences than wrap wire width can be compensated for. At present, most wire wrapped screens meet a screen gauge tolerance of +0.001/−0.002 inches (0.001 over gauge and 0.002 under gauge). Utilizing the concepts described herein, the screen gauge tolerance can be tightened. For example, tolerances of +0.0005/−0.0001 or tighter can be achieved.

Another advantage is that fewer out of spec screens are obtained. Typically, if a screen is constructed that does not meet spec, and the defect cannot be corrected, the screen is discarded. By compensating for wrap wire width and variances in screen gauge during the construction of the wire wrapped screen, fewer, if any, screens are constructed that do not meet spec.

A number of embodiments of the invention have been described. Nevertheless, it will be understood that various modifications may be made without departing from the spirit and scope of the invention. For example, although the illustrative wrap wire system described herein moves the wire wrapped screen being constructed along its longitudinal axis relative to the wrap wire feed assembly and welding arm, it is within the scope of the invention that the wrap wire feed assembly and welding arm be moved along the longitudinal axis of the wire wrapped screen being constructed. In such an instance, the transit rate of the wrap wire feed assembly and welding arm, rather than the transit rate of the wire wrapped screen, is adjusted in controling the screen gauge. Also, the wrap wire dimensional analyzer system and/or screen gauge analyzer system can be used apart from the control of the tail support transit rate and the head rotational rate. In such an instance, the measurement data concerning the wire wrapped screen is collected during the wire wrapping process without compensating for variance in the measured dimensions during the wire wrapping process. Accordingly, other embodiments are within the scope of the following claims.

1. A device for constructing a wire wrapped screen, the device comprising:
a screen body carrier adapted to carry an elongate screen body being rotated substantially about a screen body longitudinal axis;
a wrap wire feed adapted to guide a wrap wire being wound about the screen body, the screen body carrier and wrap wire feed cooperate to move at least one of the screen body and wrap wire relative to the other and substantially parallel to the screen body longitudinal axis to wrap the wrap wire substantially helically about the screen body as the screen body rotates;
a gauge measurement device adapted to measure a dimension between adjacent wraps of the wrap wire on the screen body; and
a controller coupled to the gauge measurement device and adapted to adjust the wrapping of the wrap wire about the screen body to affect the dimension between adjacent wraps of wire on the screen body in relation to the measured dimension between adjacent wraps of the wrap wire on the screen body.

2. The device of claim 1 further comprising:
a wrap wire measurement device adapted to measure a dimension of the wrap wire; and
wherein the controller is coupled to the wrap wire measurement device and adapted to adjust the wrapping of the wrap wire about the screen body in relation to the measured dimension of the wrap wire.

3. The device of claim 2 wherein the measured dimension comprises a width of the wrap wire.

4. The device of claim 1 wherein the controller is adapted to adjust at least one of a rotational rate of the screen body and a rate of movement between the screen body and the wrap wire substantially parallel to the screen body longitudinal axis to affect a distance between adjacent wraps of wrap wire on the screen body.

5. The device of claim 4 wherein the controller is adapted to at least one of decrease the rate of movement and increase the rotational rate if the measured dimension between adjacent wraps of the wrap wire on the screen body increases.

6. The device of claim 4 wherein the controller is adapted to maintain the rate of movement and the rotational rate if a variation in the dimension between adjacent wraps of the wrap wire on the screen body is less than a specified tolerance.

7. The device of claim 2 wherein the controller is adapted to adjust at least one of a rotational rate of the screen body and a rate of movement between the screen body and the wrap wire substantially parallel to the screen body longitudinal axis to affect a distance between adjacent wraps of wrap wire on the screen body; and
wherein the measured dimension comprises a width of the wrap wire and the controller is adapted to at least one of increase the rate of movement and decrease the rotational rate if the width of the wrap wire increases.

8. The device of claim 2 wherein the controller is adapted to adjust at least one of a rotational rate of the screen body and a rate of movement between the screen body and the wrap wire substantially parallel to the screen body longitudinal axis to affect a distance between adjacent wraps of wrap wire on the screen body; and
wherein the controller is adapted to maintain the rate of movement and the rotational rate if a variation in the measured dimension of the wrap wire is less than a specified tolerance.

9. The device of claim 1 wherein the controller is adapted to log measurements of the dimension between adjacent wrap wires.

10. The device of claim 2 wherein the controller is adapted to log measurements of the wrap wire dimension.

11. The device of claim 1 wherein the screen body comprises at least one of a plurality of elongate wires extending along the screen body longitudinal axis, a tubular body extending along the screen body longitudinal axis and having one or more apertures through a wall of the tubular body, and a wire wrapped screen extending along the screen body longitudinal axis and having a plurality of elongate wires affixed axially to an exterior of the wire wrapped screen.

12. The device of claim 1 further comprising:
a compression member adapted to abut the wrap wire and compress the wrap wire to the screen body;
a compression member actuator adapted to affect a load applied by the compression member in compressing the wrap wire to the screen body; and
wherein the controller is coupled to the compression member actuator and adapted to adjust the load applied in compressing the wrap wire to the screen body.

13. The device of claim 12 wherein the compression member actuator is at least one of a pneumatic cylinder and a hydraulic cylinder, and wherein the controller is adapted to adjust a pressure supplied to the cylinder.

14. The device of claim 12 wherein a current is applied across the wrap wire and screen body and wherein the controller is adapted to adjust the load applied in compressing the wrap wire to the screen body so that the current welds the wrap wire to the screen body.

15. The device of claim 1 further comprising:
a power source adapted to apply a current across the wrap wire and the screen body; and
wherein the controller is coupled to the power source and adapted to adjust the current.

16. The device of claim 1 wherein a screen length is specified to the controller and wherein the controller ceases movement between the screen body and wrap wire substantially parallel to the screen body longitudinal axis in relation to the specified screen length.

17. The device of claim 1 wherein the gauge measurement device measures the dimension between adjacent wraps of wrap wire on the screen body at least one of periodically and continuously during an interval while wrapping the wrap wire about the screen body.

18. The device of claim 2 wherein the wrap wire measurement device measures the dimension of the wrap wire at least one of periodically and continuously during an interval while wrapping the wrap wire about the screen body.

19. The device of claim 1 further comprising a marking device coupled to the controller; and
wherein the controller is adapted to actuate the marking device to mark the wire wrapped screen.

20. The device of claim 20 wherein the controller is adapted to actuate the marking device if a variation in the measured dimension between adjacent wraps of the wrap wire on the screen body exceeds a specified tolerance.

21. The device of claim 21 wherein the controller is adapted to actuate the marking device so that a location of the mark substantially coincides with a location of the variation on the wire wrapped screen.

22. The device of claim 20 wherein the controller is adapted to actuate the marking device to mark the wire wrapped screen with different marks in relation to the measured dimension between adjacent wraps of the wrap wire on the screen body.

23. The device of claim 1 wherein the gauge measurement device is an optical measurement device.

24. The device of claim 1 wherein the gauge measurement device comprises a video imager.

25. The device of claim 1 wherein the controller is adapted to adjust the wrapping of the wrap wire about the screen body while the wrap wire is being wrapped about the screen body.

26. A screen fabricating device comprising:
a screen body carrier adapted to carry an elongate screen body being rotated substantially about a screen body longitudinal axis;
a wrap wire feed adapted to guide a wrap wire being wound about the screen body, the screen body carrier and wrap wire feed cooperate to move at least one of the screen body and wrap wire relative to the other and substantially parallel to the screen body longitudinal axis to wrap the wrap wire substantially helically about the screen body as the screen body rotates;
a wrap wire measurement device adapted to measure a dimension of the wrap wire; and
a controller coupled to the wrap wire measurement device and adapted to adjust the wrapping of the wrap wire about the screen body to affect the dimension between adjacent wraps of wire on the screen body in relation to the measured dimension of the wrap wire.

27. The screen fabricating device of claim 26 wherein the measured dimension is a width of the wrap wire.

28. The screen fabricating device of claim 26 wherein the controller is adapted to adjust at least one of a rotational rate of the screen body and a rate of movement between the screen body and the wrap wire substantially parallel to the screen body longitudinal axis to affect a distance between adjacent wraps of wire on the screen body.

29. The screen fabricating device of claim 28 wherein the controller is adapted to at least one of increase the rate of movement and decrease the rotational rate if the wrap wire dimension increases.

30. The screen fabricating device of claim 28 wherein the controller is adapted to maintain the rate of movement and rotational rate if a variance in the wrap wire dimension is less than a specified tolerance.

31. The screen fabricating device of claim 26 wherein the controller is adapted to log measurements of the wrap wire dimension.

32. The screen fabricating device of claim 26 wherein the screen body comprises a plurality of elongate wires spaced about the screen body longitudinal axis.

33. The screen fabricating device of claim 26 further comprising:
a compression member adapted to abut the wrap wire and compress the wrap wire to the screen body;
a compression member actuator adapted to affect a load applied by the compression member in compressing the wrap wire to the screen body; and
wherein the controller is coupled to the compression member actuator and adapted to adjust the load applied in compressing the wrap wire to the screen body.

34. The screen fabricating device of claim 26 further comprising:
a power source adapted to apply a current across the wrap wire and the screen body; and
wherein the controller is coupled to the power source and adapted to adjust the current.

35. The screen fabricating device of claim 26 wherein the wrap wire measurement device is adapted to measure the dimension of the wrap wire continuously while wrapping the wrap wire about the screen body.

36. The screen fabricating device of claim 26 further comprising a marking device coupled to the controller; and
wherein the controller is adapted to actuate the marking device to mark the wire wrapped screen.

37. The screen fabricating device of claim 36 wherein the controller is adapted to actuate the marking device if a variation in the measured dimension of the wrap wire exceeds a specified tolerance.

38. The screen fabricating device of claim 37 wherein the controller is adapted to actuate the marking device so that a location of the mark substantially coincides with a location of the variation on the wire wrapped screen.

39. The screen fabricating device of claim 36 wherein the controller is adapted to actuate the marking device to mark the wire wrapped screen with different marks in relation to the dimension of the wrap wire.

40. The screen fabricating device of claim 26 wherein the wrap wire measurement device is an optical measurement device.

41. The screen fabricating device of claim 26 wherein the wrap wire measurement device comprises a video imager.

42. The screen fabricating device of claim 26 wherein the controller is adapted to adjust the wrapping of the wrap wire about the screen body while the wrap wire is being wrapped about the screen body.

43. A method of constructing a screen comprising:
wrapping a wire substantially helically about a screen body as the screen body rotates and at least one of the wire and screen body is translated substantially parallel to a screen body longitudinal axis;
measuring a dimension between adjacent wraps of the wire on the screen body continuously during one or more intervals while wrapping the wire about the screen body; and
adjusting the wrapping of the wire about the screen body to affect the dimension between adjacent wraps of wire on the screen body in relation to the measured dimension between adjacent wraps of the wire on the screen body.

44. The method of claim 43 further comprising:
measuring a dimension of the wire while wrapping the wire about the screen body; and
adjusting the wrapping of the wire about the screen body to affect the dimension between adjacent wraps of wire on the screen body in relation to the measured dimension of the wire.

45. The method of claim 44 wherein measuring a dimension of the wire comprises measuring a width of the wire.

46. The method of claim 43 wherein adjusting the wrapping of the wire about the screen body comprises adjusting at least one of a rate of movement between the screen body and wire substantially parallel to the screen body longitudinal axis and a rotational rate of the screen body about the screen body longitudinal axis.

47. The method of claim 46 wherein adjusting the wrapping of the wire about the screen body comprises at least one of increasing the rate of movement and decreasing the rotational rate if the dimension between adjacent wraps of the wire decreases.

48. The method of claim 46 wherein adjusting the wrapping of the wire about the screen body comprises maintaining the rate of movement and rotational rate substantially constant if a variation in the dimension between adjacent wraps of the wire is less than a specified tolerance.

49. The method of claim 44 wherein adjusting the wrapping of the wire about the screen body comprises at least one of increasing a rate of movement between the screen body and wire substantially parallel to the screen body longitudinal axis and decreasing a rotational rate of the screen body about the screen body longitudinal axis if the width of the wire increases.

50. The method of claim 44 wherein adjusting the wrapping of the wire about the screen body comprises maintaining a rate of movement between the screen body and wire substantially parallel to the screen body longitudinal axis and a rotational rate of the screen body about the screen body longitudinal axis substantially constant if a variation in the measured dimension of the wire is less than a specified tolerance.

51. The method of claim 43 further comprising logging measurements of the dimension between adjacent wraps of the wire.

52. The method of claim 44 further comprising logging measurements of the measured dimension of the wire.

53. The method of claim 43 wherein adjusting the wrapping of the wire about the screen body comprises adjusting the wrapping of the wire about the screen body while wrapping the wire about the screen body.

54. The method of claim 43 further comprising marking the screen while wrapping the wire about the screen body to indicate a variance in the measured dimension between adjacent wraps of the wire.

55. The method of claim 54 further comprising marking the screen so that a location of the mark substantially coincides with a location of the variance on the screen.

56. The method of claim 43 comprising measuring a dimension between adjacent wraps with an optical measurement device.

57. A method of constructing a screen comprising:
wrapping a wire substantially helically about a screen body as the screen body rotates and at least one of the wire and screen body is translated substantially parallel to a screen body longitudinal axis;
measuring a dimension of the wire continuously during one or more intervals while wrapping the wire about the screen body; and
adjusting the wrapping of the wire about the screen body to affect the dimension between adjacent wraps of wire on the screen body in relation to the measured dimension of the wire.

58. The method of claim 57 wherein the measured the dimension of the wire comprises measuring a width of the wire.

59. The method of claim 57 wherein adjusting the wrapping of the wire about the screen body comprises adjusting at least one of a rate of movement between the screen body and wire substantially parallel to the screen body longitudinal axis and a rotational rate of the screen body about the screen body longitudinal axis.

60. The method of claim 59 wherein adjusting the wrapping of the wire about the screen body comprises at least one of increasing the rate of movement and decreasing the rotational rate if the dimension of the wire increases.

61. The method of claim 59 wherein adjusting the wrapping of the wire about the screen body comprises maintaining the rate substantially constant if a variation in the measured dimension of the wire is less than a specified tolerance.

62. The method of claim 57 further comprising logging measurements of the measured dimension of the wire.

63. The method of claim 57 further comprising marking the screen during the wrapping of the wire about the screen body to indicate a variance in the dimension of the wire.

64. The method of claim 57 further comprising marking the screen so that a location of the mark substantially coincides with a location of the variance on the screen.

65. The method of claim 57 comprising measuring a dimension of the wire with an optical measurement device.

66. A device for constructing a wire wrapped screen, comprising:
a screen body carrier adapted to carry an elongate screen body;
a wrap wire feed adapted to guide a wrap wire being wound substantially helically about the screen body;
a measurement device adapted to measure at least one of a dimension between adjacent wraps of wire about the screen body and a dimension of the wrap wire;
a marking device actuable to mark the wire wrapped screen; and
a controller coupled to the measurement device and the marking device, the controller adapted to actuate the marking device in relation to a measured dimension from the measurement device.

67. The device of claim 66 wherein the controller is adapted to actuate the marking device when a variance in the measured dimension exceeds at least one of a high tolerance and a low tolerance.

68. The device of claim 66 wherein the controller is adapted to actuate the marking device so that a location of the mark substantially coincides with a location of a variance of the measured dimension on the wire wrapped screen.

69. The device of claim 66 wherein the controller is adapted to actuate the marking device to mark the wire wrapped screen with different marks in relation to the measured dimension.

70. The device of claim 69 wherein the different marks differ in at least one of color, size, and shape.

71. The device of claim 66 wherein the controller is adapted to actuate the marking device with a mark having at least two distinguishable characteristics, wherein a first characteristic is indicative of what measured dimension the mark corresponds to and a second characteristic is indicative of a magnitude of the measured dimension.

72. The device of claim 66 wherein the mark comprises text.

73. The device of claim 66 wherein the controller is adapted to actuate the marking device while winding the wrap wire about the screen body.

74. The device of claim 66 wherein the controller is adapted to adjust the winding of the wrap wire about the screen body to affect the dimension between adjacent wraps of wire about the screen body in relation to the measured dimension.

75. The device of claim 66 wherein the gauge measurement device is an optical measurement device.

76. The device of claim 66 wherein the gauge measurement device comprises a video imager.

77. A method of constructing a screen, comprising:
wrapping a wire substantially helically about a screen body;
measuring at least one of a dimension between adjacent wraps of wire about the screen body and a dimension of the wrap wire; and
marking the screen while wrapping the wire about the screen body in relation to the measured dimension.

78. The method of claim 77 comprising marking the screen when a variance in the measured dimension exceeds a specified tolerance.

79. The method of claim 77 comprising marking the screen with a mark that substantially coincides in location with a location of a variance in the measured dimension on the screen.

80. The method of claim 77 comprising marking the screen with different marks in relation to the measured dimension.

81. The method of claim 77 comprising marking the screen with a mark having at least two distinguishable characteristics, wherein a first characteristic is indicative of what measured dimension the mark corresponds to and a second characteristic is indicative of a magnitude of the measured dimension.

82. The method of claim 81 wherein the first characteristic is a shape of the mark and the second characteristic is a color of the mark.

83. The method of claim 77 comprising marking the screen with text.

84. The method of claim 77 comprising adjusting the wrapping of the wrap wire about the screen body to affect the dimension between adjacent wraps of wire about the screen body in relation to the measured dimension.

85. The method of claim 77 comprising measuring at least one of a dimension between adjacent wraps of wire about the screen body and a dimension of the wrap wire with an optical measurement device.

86. The method of claim 77 comprising logging the measured dimension.

87. A device for constructing a wire wrapped screen, comprising:
a screen body carrier adapted to carry an elongate screen body;
a wrap wire feed adapted to guide a wrap wire being wound substantially helically about the screen body; and
at least one measurement device adapted to measure at least one of a dimension between adjacent wraps of wire about the screen body and a dimension of the wrap wire while the wrap wire is being wrapped about the screen body.

88. The device of claim 87 further comprising a memory coupled to the measurement device, the memory adapted to receive and store measurement data from the measurement device.

89. The device of claim 88 wherein the measurement data is correlated to a length of the wire wrapped screen.

90. The device of claim 87 further comprising a controller coupled to the measurement device adapted to adjust the wrapping of the wrap wire about the screen body to affect the dimension between adjacent wraps of wire on the screen body in relation to the measured dimension.

91. The device of claim 87 further comprising a marking device adapted to mark the screen in relation to the measured dimension.

92. The device of claim 87 wherein the dimension of the wrap wire comprises a width of the wrap wire.

93. The device of claim 87 wherein the measurement device comprises an optical measurement device.

94. The device of claim 93 wherein the measurement device comprises a video imager.

95. A method of constructing a screen, comprising:
wrapping a wire substantially helically about a screen body; and
measuring at least one of a dimension between adjacent wraps of wire about the screen body and a dimension of the wrap wire while the wire is being wrapped substantially helically about the screen body.

96. The method of claim 95 wherein wrapping the wire substantially helically about the screen body comprises rotating the screen body about a screen body longitudinal axis as the wire is being wrapped substantially helically about the screen body; and
wherein measuring at least one of a dimension between adjacent wraps of wire about the screen body and a dimension of the wrap wire comprises measuring while the screen body is rotating.

97. The method of claim 95 further comprising logging measurement data.

98. The method of claim 96 further comprising correlating the measurement data to a length of the screen.

99. The method of claim 95 further comprising adjusting the wrapping of the wire about the screen body to affect the dimension between adjacent wraps of wire about the screen body in relation to a measurement of at least one of a dimension between adjacent wraps of wire about the screen body and a dimension of the wrap wire.

100. The method of claim 95 further comprising marking the screen in relation to a measurement at least one of a dimension between adjacent wraps of wire about the screen body and a dimension of the wrap wire.

101. The method of claim 95 wherein the dimension of the wrap wire comprises a width of the wrap wire.

102. The method of claim 95 wherein measuring at least one of a dimension between adjacent wraps of wire about the screen body and a dimension of the wrap wire is measuring with an optical measurement device.
